(19) United States
(12) Patent Application Publication
(10) Pub. No.: US 2026/0277770 A1
(43) Pub. Date: Sep. 17, 2026

(54) SYSTEMS AND METHODS FOR ANOMALY ALERTING FOR DATA FEEDS

(71) Applicant: Target Brands, Inc., Minneapolis, MN (US)

(72) Inventors: John Michael Schoonover, Rogers, MN (US); Christina Rene Carlson, Forest Lake, MN (US); Caleb Walch, Minneapolis, MN (US); David Allen Lazar, Beavercreek, OH (US)

(21) Appl. No.: 19/077,647

(22) Filed: Mar. 12, 2025

(51) Int. Cl. G06F 11/34; G06F 11/30

(52) U.S. Cl. CPC G06F 11/3476; G06F 11/3086

(57) ABSTRACT

In some implementations systems and methods for alerting can include receiving a plurality of event logs from a data feed. Compliance with a schema can be determined for each event log of the plurality of event logs. The plurality of event logs is stored in a data store. For each event log of the plurality of event logs, the storing can include indicating field error information. One or more compliance metrics for the data feed are generated for a period of time. The one or more compliance metrics are generated based on the field error information for the plurality of event logs. The one or more compliance metrics can be compared with one or more alert thresholds. Based on the comparing with the one or more alert thresholds, one or more anomaly alerts are sent.

### TECHNICAL FIELD

This specification generally relates to technology for alerting for monitored data feeds.

### BACKGROUND

Network security generally includes monitoring computer networks for various types of threats such as cybersecurity threats. Employment of rules-based monitoring tools and protection systems can generally involve creating rules for identifying the threats. As rules-based monitoring can be employed through applying rules to network data, unexpected changes in network data can be abrupt and hinder rules-based monitoring.

### SUMMARY

This document generally describes computer systems, processes, program products, and devices for sending anomaly alerts for data feeds.

In some implementations, a method for the disclosed technology can include receiving a plurality of event logs from a data feed. The method further includes determining compliance with a schema for each event log of the plurality of event logs. The method further includes storing the plurality of event logs in a data store such that the storing includes, for one or more event logs of the plurality of event logs, indicating field error information. The method further includes generating one or more compliance metrics for the data feed for a period of time such that the compliance metrics are generated based on field error information for the plurality of event logs. The method further includes comparing the one or more compliance metrics with one or more alert thresholds. The method further includes sending one or more anomaly alerts based on the comparing with the one or more alert thresholds.

In some implementations, a computer system can alert. The computer system can include one or more processors and computer readable memory storing instructions that, when executed by the processors, cause the processors to perform operations including receiving a plurality of event logs from a data feed. The operations further include determining compliance with a schema for each event log of the plurality of event logs. The operations further include storing the plurality of event logs in a data store, wherein the storing includes, for one or more event logs of the plurality of event logs, indicating field error information. The operations further include generating one or more compliance metrics for the data feed for a period of time, wherein the one or more compliance metrics are generated based on field error information for the plurality of event logs. The operations further include comparing the one or more compliance metrics with one or more alert thresholds. The operations further include sending one or more anomaly alerts based on the comparing with the one or more alert thresholds.

Other implementations of this aspect include corresponding computer systems, and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. Comparing an event log of the plurality of event logs to the schema and based on the comparing the event log, adding schema error data to the event log if one or more fields of the event log do not correspond with the schema. For each event log of the plurality of event logs, enriching the event log, wherein the enriching includes formatting the event log based on a JSON format. Based on the comparing the one or more compliance metrics with the alert threshold, determining that at least one of the one or more compliance metrics exceed the alert threshold. The alert threshold is based on one or more historical compliance metrics for the data feed. The sending of the one or more of the anomaly alerts is further based on the determination that the at least one of the one or more compliance metrics exceed the alert threshold. The alert threshold is based on one or more historical compliance metrics for a designated field of the data feed. The one or more historical compliance metrics for the data feed are based on a cyclical time period for the data feed. The one or more compliance metrics include a percentage of the event logs that include one or more unsearchable fields. The schema is based on one or more fields used by one or more rules for rules-based detection. The compliance metrics are generated based further on unsearchable fields of the plurality of event logs.

The systems, devices, program products, and processes described throughout this document can, in some instances, provide one or more of the following advantages. In some implementations, active monitoring and alerting of data quality issues can increase detection efficacy in rules-based monitoring and detection as data quality issues can be addressed timely. Monitoring data feeds to identify data quality issues can allow for the timely resolution of data quality issues and reduced time of exposure to threats.

Other features, aspects and potential advantages will be apparent from the accompanying description and figures.

### DESCRIPTION OF DRAWINGS

FIG. 1 is a diagram showing an exemplary system for sending one or more anomaly alerts for one or more data feeds.

FIG. 2 is a flowchart diagram for an exemplary process for sending one or more anomaly alerts for one or more data feeds.

FIG. 3 is a flowchart diagram for an exemplary process for storing an event log with associated field error information in a data store.

FIG. 4 is a diagram showing a technique for adding field error information to one or more event logs from one or more data feeds.

FIG. 5 is a flow diagram for an exemplary process for sending one or more anomaly alerts for one or more data feeds.

FIG. 6 is a diagram showing a technique for sending one or more anomaly alerts for a first data feed.

FIG. 7 is a diagram that shows an exemplary timeline for receiving event logs from a data feed at a data store where one or more compliance metrics for various time periods are generated.

FIG. 8 is a diagram depicting an exemplary process for sending one or more anomaly alerts for a data feed based on a determination that one or more compliance metrics exceed at least one of one or more alert thresholds.

FIG. 9 is a schematic diagram that shows an example of a computing system.

Like reference symbols in the various drawings indicate like elements.

### DETAILED DESCRIPTION

This document describes technology that can send anomaly alerts for monitored data feeds. The described technologies can monitor data feeds for changes in data quality and/or data availability. Monitoring network data feeds can be complex and can, in part, rely on expected formatting of data within the network data feeds. Sometimes the formatting of data within data feeds can change unexpectedly. For example, an expected field in a unit of data (e.g., log, document, etc.) can be changed such that the field is formatted differently than expected based on prior formatting or the field can be removed. Generally, data formatting can be changed based on a variety of factors including but not limited to changes to application software, system updates, or system errors. Data formatting can be important generally when used to implement rules for rules-based monitoring of data feeds or other monitoring tools or processes. For example, the formatting of data from data feeds can change over time and can impact downstream monitoring tools and/or processes that rely on expected data formats.

In another example, in the context of a system for security information and event management (SIEM), a SIEM system can include rules for rules-based monitoring that can be less effective if monitored data no longer conforms to formats relied upon by the rules. In some implementations a SIEM system can collect logs from various data sources and can use the collected logs to determine possible security threats. In some implementations, analysis of logs, for example, can be rules based, and rules can be generated based on a specified data document organization and/or fields found in a data document.

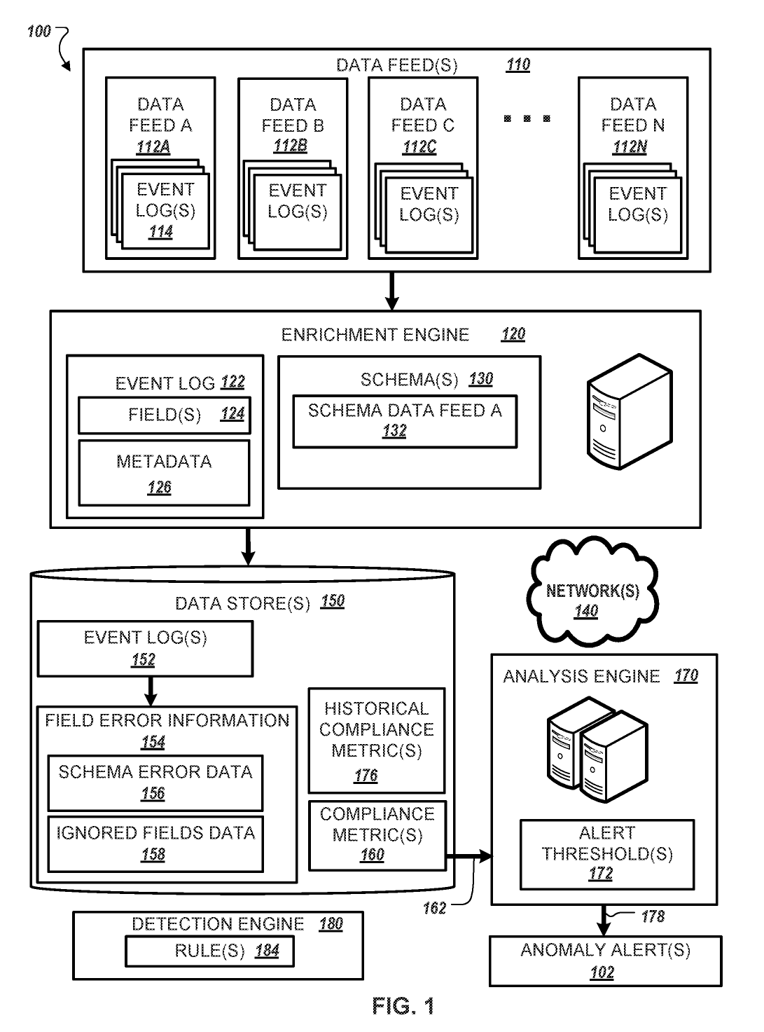

With reference to FIG. 1, FIG. 1 is a diagram showing an exemplary system 100 for sending one or more anomaly alerts 102 for one or more data feeds 110. The one or more data feeds 110 include data feeds 112A-N. The one or more anomaly alerts 102 can be used to monitor changes in one or more fields of data provided by the one or more data feeds 110. In some implementations, data within a data feed can include data that is continually collected, and/or stored in real-time, as the data is being collected from one or more data sources. For example, a data feed can include a collection of event logs communicated over time provided by a data source. Further, each data feed, for example, can represent data from a different data collection system (e.g., data source) and/or a different type of data. For example, a data feed can include network traffic data for various computing nodes across an enterprise’s computer network, a second data feed can include sensor data (e.g., badge scan data, data based on image sensors, etc.) that represents actions that occurred in a physical environment, and so forth. Also, for example, data feeds can include log data from data sources including enterprise systems, network systems, cybersecurity systems, sensors, monitoring systems, applications, and/or other data sources.

In some implementations, the data feeds 110, for example, can include a vast amount of data (e.g., terabytes, petabytes). In one example, an enterprise data network that connects hundreds of physical locations and millions of devices and/or applications can be effectively and efficiently monitored using tens of thousands of data sources (e.g., sensors, applications, etc.) producing data feeds including tens of trillions of events a day (including hundreds of thousands or millions of events a second). In some implementations, a data feed can include but is not limited to an event stream (e.g., KAFKA events, GOOGLE CLOUD Pub/Sub messages, etc.), log information, and/or other data feed. In some implementations, the one or more data feeds 110 can be from one or more data sources that are monitored by one or more monitoring and/or detection systems such as detection engine 180. The detection engine 180 can include a rules-based monitoring system (e.g., SIEM system, etc.) that uses one or more rules 184 in monitoring the data feeds 110. In some implementations, the detection engine 180 can be designed to process, access, and use data from the one or more data feeds 110 to track and monitor data included in the one or more data feeds 110 to identify events (e.g., cybersecurity events, failures, etc.). In some implementations, the one or more data feeds 110 and/or other described communications (e.g., data, an event log, etc.) can be sent and/or received using one or more communications networks 140.

The one or more data feed(s) 110 can include one or more event logs such as the one or more event logs included in a first data feed 112A. The one or more event logs can include logs from various data sources included in the data feeds. In some implementations, an event log can be generated and/or sent for a data feed based on an event occurrence of the data source for the data feed. Thus, the technology described herein can facilitate a monitoring of collected log data across disparate systems.

The one or more event logs from the one or more data feeds 110 can be received at an enrichment engine 120 where the received one or more event logs can be enriched. In some implementations, a received event log can include structured data that is structured in an expected format provided by a data feed. As event logs from various data sources with various data formats can be received, enrichment can prepare the event logs for storage within one or more data stores 150. In some implementations, the enrichment can include but is not limited to formatting data of the event log, adding data to the event log, reorganize data of the event log, or other enrichment. For example, an event log such as event log 122 can be enriched to reorganize included data into a format suitable for ingestion into the data store 150. In some implementations, the enrichment of the event log 122 can include formatting the data of the event log 122 using a standardized data format such as the JavaScript Object Notation (JSON) or other standardized data format. In some implementations, the enrichment of the event log 122 can include formatting the data of the event log 122 to a different format. During enrichment of the event log 122, one or more fields 124 included in the event log 122 can be compared to a first schema 132 of one or more schemas 130 to determine compliance with the first schema 132. The one or more schemas 130 can represent one or more expected data formats for one or more event logs for the one or more data feeds 110. For example, the first schema 132 can represent an expected data format for the one or more fields 124 included in the event log 122 received from the first data feed 112A. Based on the comparison, if at least some of the one or more fields 124 are not compliant with the first schema 132, metadata 126 can be added to the event log 122. The metadata 126 can include field error information including information indicating what fields of the one or more fields 124 were not compliant with the first schema 132 (e.g., schema error data).

After enrichment, the one or more event logs of the one or more data feeds can be sent to be ingested into the one or more data stores 150 for storage. In some implementations, the ingestion into the data store 150 for the one or more event logs can include generating field error information that includes but not limited to indications of which fields of an ingested event log are malformed, ignored, or otherwise unsearchable within the data store 150. For example, an event log that is missing an expected field and/or includes field data of an unexpected type or format can be associated with information indicating that the field is ignored for the event log within the data store 150. In some implementations the one or more data stores 150 can include field error information 154 that is associated with the one or more event logs 152. For example, the field error information 154 can include schema error data 156, ignored fields data 158, and/or other field error information.

After the one or more event logs 152 are stored in the one or more data stores 150 over a period of time, one or more compliance metrics 160 can be generated and included in the one or more data stores 150. The one or more compliance metrics 160 can be generated from the information for the one or more event logs 152 included in the one or more data stores 150. For example, the one or more data stores 150 can be queried to determine an amount of the one or more event logs 152 for a data feed received withing a period of time that include malformed or otherwise unsearchable fields that do not comply with expected data formats. As shown at 162, the one or more compliance metrics 160, for example, can be used by an analysis engine 170 to determine how the one or more compliance metrics compare to one or more alert thresholds 172. For example, based on a comparison, the one or more compliance metrics 160 can be determined to exceed or not exceed the one or more alert thresholds 172 by the analysis engine 170. In some implementations, the one or more alert thresholds 172 can be based on one or more historical compliance metrics 176. For example, the one or more historical compliance metrics 176 can be compliance metrics for one or more data feeds over a period of time in the past that can be referenced to determine the one or more alert thresholds 172. Based on the comparison between the one or more compliance metrics 160 and the one or more alert thresholds 172, one or more anomaly alerts 102 can be sent as shown at 178. For example, the one or more anomaly alerts 102 can be sent based on the analysis engine determining that the one or more compliance metrics 160 exceed the one or more alert thresholds 172. In some implementations, the one or more anomaly alerts 102 can identify one or more changes to data fields and/or attributes of data feeds that can be investigated and/or resolved for use with rules-based monitoring and detection.

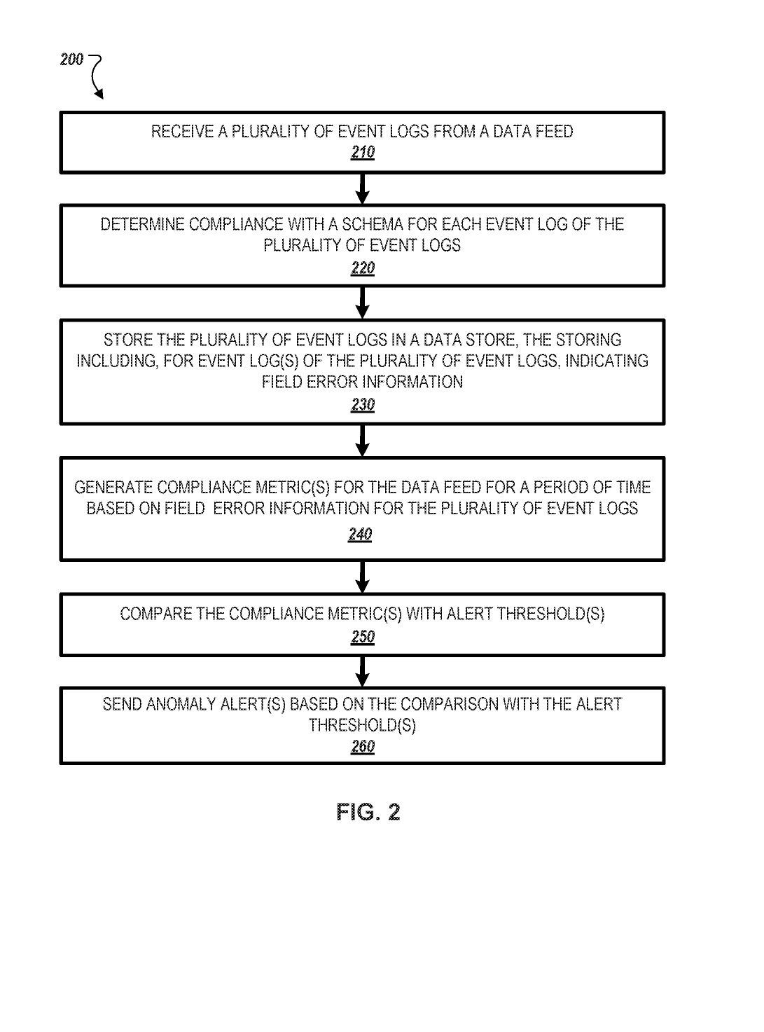

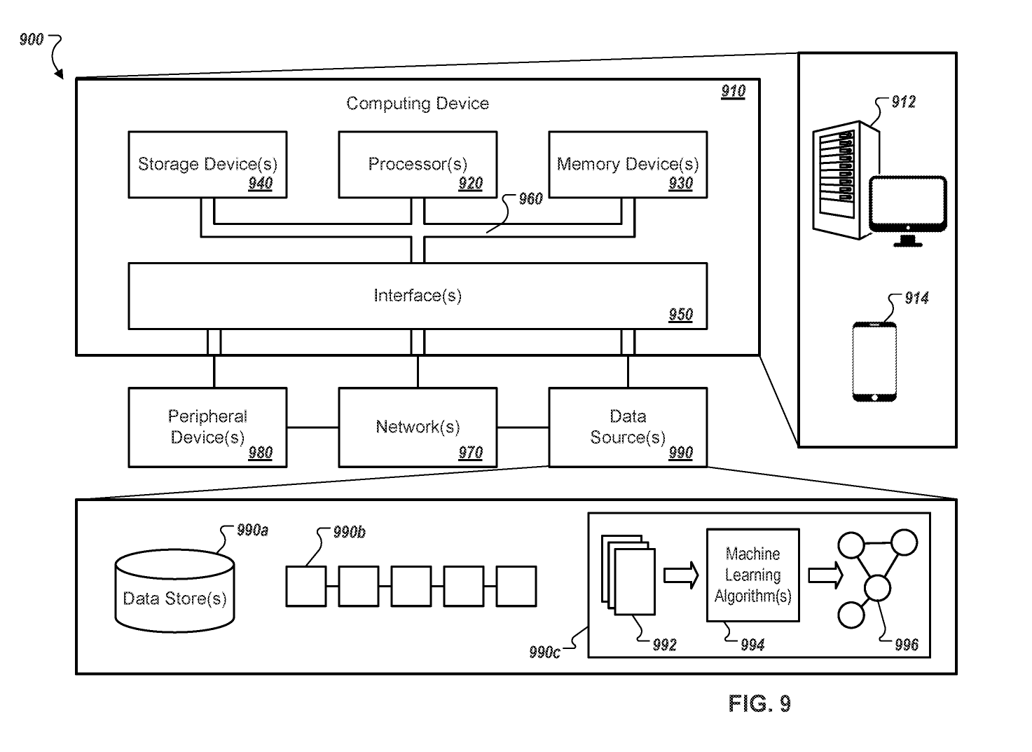

FIG. 2 is a diagram showing an exemplary process 200 for sending one or more anomaly alerts for a data feed. The process 200 can be performed using one or more computing systems, as described and depicted herein. For example, the process 200 can be performed using the computing system 900 in FIG. 9. At 210 in FIG. 2, a plurality of event logs from a data feed are received. At 220, compliance with a schema is determined for each event log of the plurality of event logs. At 230, the plurality of event logs is stored in a data store. The storing of the plurality of event logs can include indicating field error information for one or more event logs of the plurality of event logs. In some implementations, the field error information can include indicating one or more fields are ignored, malformed, or otherwise unsearchable in the data store.

At 240, one or more compliance metrics are generated for the data feed for a period of time. In some implementations, the one or more compliance metrics for the data feed can be generated based on the plurality of event logs for the data feed. For example, in some implementations, the one or more compliance metrics can be based on field error information including schema error data and/or ignored field data for the plurality of event logs for the data feed. In some implementations, the generation of the one or more compliance metrics can include querying the data store for field error information associated with the plurality of event logs for the data feed. In some implementations, the generation of the one or more compliance metrics can include determining, for a period of time (e.g., seconds, minutes, hours, days, weeks, etc.), a count of the plurality of event logs for a designated data feed that include fields with errors based on field error information for the plurality of event logs. For example, a compliance metric included in the one or more compliance metrics can provide a count (e.g., an amount, a percentage, etc.) of event logs that include a field that has an error such that it is not compliant with an expected format which can including but is not limited to a missing field, a false field, field with an incorrect data type, field in an unexpected location, an ignored field, an unsearchable field, a malformed field, and/or otherwise noncompliant field. In some implementations the one or more compliance metrics can include a percentage of the plurality of event logs that include fields that are associated with field error information. In another exemplary implementation, the one or more compliance metrics can include a percentage of the plurality of event logs that do not include fields that are associated with field error information. In some implementations, one or more queries of the data store can be made to identify and/or count event logs with field error information for one or more specified fields. In some implementations, the one or more compliance metrics can be based on any of a variety of fields included in the event logs. In some implementations, the one or more compliance metrics are based on fields for the plurality of event logs that that are used for rules-based detection and/or monitoring. In some implementations, the compliance metrics can include information indicating the fields that have errors for the event logs that are counted. For example, a compliance metric can include information about a percentage of the plurality of event logs that include ignored fields and can include information identifying the ignored fields. In some implementations, a compliance metric can be generated for a period of time based on a designated cyclical time period for the data feed. For example, the data feed can be monitored over periods of time that occur cyclically including but not limited to a particular day of the week, days of a week, days of a month, days of a year, or other cyclical period of time. In other implementations, the one or more compliance metrics can be determined over other periods of time based on other criteria. In some implementations, historical compliance metrics can include compliance metrics generated for a prior period of time and/or cyclical time period for the data feed.

At 250 the one or more compliance metrics are compared with one or more alert thresholds. In some implementations, an alert threshold can be set to detect changes in event logs of the data feed that are anomalous and/or outside of an acceptable amount (e.g., range, count, etc.). For example, as data is received and stored in the data store over time for the data feed, the data (e.g., fields, data in fields, field types, field locations, etc.) included in event logs of the data feed can change unexpectedly from the expected format, and an alert threshold can be set to detect an amount of event logs that are not compliant with the expected format over the period of time. In some implementations, alert thresholds can be set based on historical amounts of event logs for the data feed that have been compliant with expected formatting. For example, a data feed can be monitored over various periods of time and determined to be compliant with expected formatting over the various periods of time, and an alert threshold can be set based on the compliance metric amounts identified in the historical pattern over the monitored periods of time. Over the various periods of time, for example, the compliant data feed can have percentages of received event logs that are within an acceptable range. In some implementations, an alert threshold can be set to an amount based on an acceptable range for an amount of event logs that are not compliant with an expected format.

At 260, one or more anomaly alerts are sent based on the comparison with the one or more alert thresholds. For example, based on the comparison, if at least one of the compliance metrics is determined to exceed at least one of the alert thresholds, at least one anomaly alert can be sent for the data feed. In some implementations, an anomaly alert can be sent to alert that the data feed has changed and includes event logs that are not compliant with expected formatting based on the comparison with the compliance metrics for the data feed and the one or more anomaly thresholds. In some implementations, one or more anomaly alerts can be sent based on the compliance metrics being under an alert threshold. For example, when a compliance metric for the data feed provides a percentage of the event logs that are compliant with expected formatting and do no not include fields with errors and the comparison determines that the compliance metric is below an alert threshold, an anomaly alert can be sent based on the comparison being below the alert threshold. In some implementations, the one or more anomaly alerts can be sent based on the comparison including but not limited to when the comparison determines that the one or more compliance metrics exceed the one or more alert thresholds, when the comparison determines that the one or more compliance metrics are below the one or more alert thresholds, when the comparison determines that the one or more compliance metrics are within a range determined by the one or more alert thresholds, or when the comparison determines that the one or more compliance metrics meet the one or more alert thresholds.

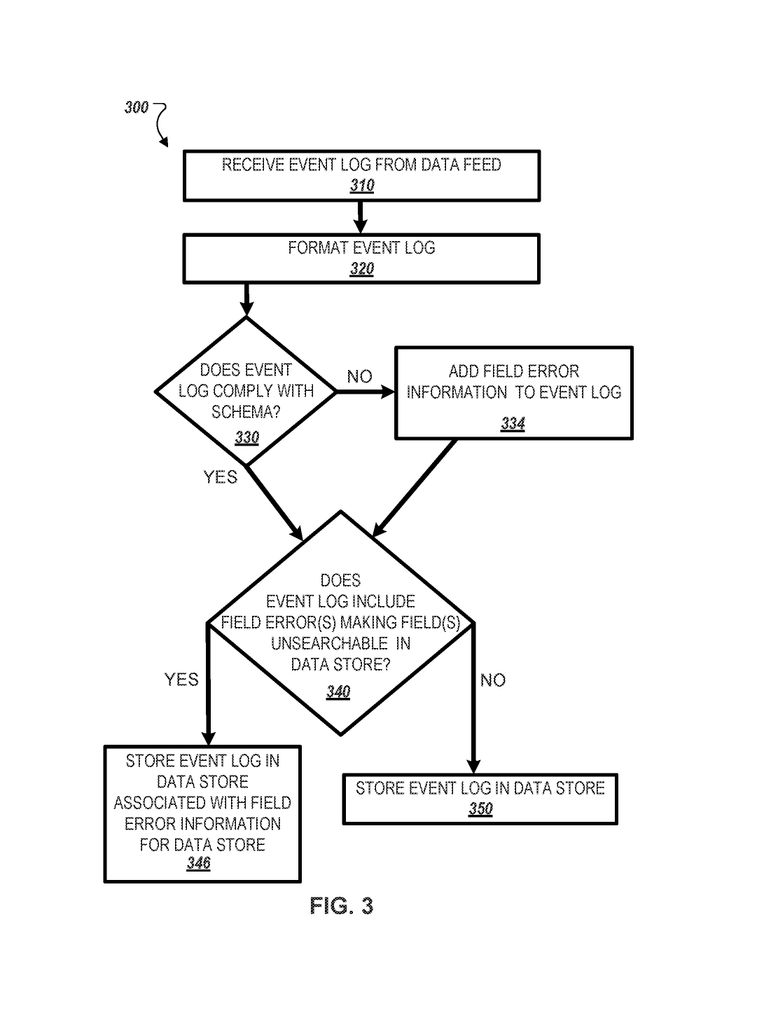

FIG. 3 is a flowchart diagram for an exemplary process 300 for storing an event log with associated field error information in a data store. The process 300 can be performed using one or more computing systems, as described and depicted herein. For example, the process 300 can be performed using the computing system 900 in FIG. 9. In FIG. 3, at 310, an event log is received from a data feed. In some implementations, for example, a data feed can send an event log, and the event log can be received by an enrichment engine. At 320, the received event log is formatted. For example, the data of the event log can be converted according to a standardized format (e.g., a JSON format). Also, for example, the data of the event log can be formatted so that the event log can be accepted for storage within a data store.

At 330, a determination is made that the formatted event log complies with a schema for the data feed or does not comply with the schema for the data feed. For example, the formatted event log can be compared to a schema to determine if the fields of the event log are compliant or are not compliant with the schema. At 334, if the determination is made that the formatted event log does not comply with the schema, field error information is added to the formatted event log. In one implementation, for example, the field error information (e.g., schema error data) indicating one or more fields of the event log are not compliant with the schema can be added as metadata to the formatted event log. In other implementations, field error information can be otherwise added to the event log. If the determination is made that the formatted event log does comply with the schema for the data feed at 330, the process can continue as shown at 340.

At 340, a determination is made that the event log has one or more field errors that make one or more fields unsearchable in a data store or that the event log does not have one or more field errors that make one or more fields unsearchable in the data store. If it is determined that that the event log has one or more field errors that make one or more fields of the event log unsearchable in the data store, at 346, the event log is stored in the data store associated with field error information for the event log within the data store. In some implementations, for example, the associated field error information for the event log can include an indication that one or more fields are ignored, malformed, or otherwise unsearchable in the data store. If it is determined that that the event log does not include one or more field errors that make one or more fields of the event log unsearchable in the data store, at 350, the event log is stored in the data store (e.g., a database, a search engine, a distributed search engine, etc.).

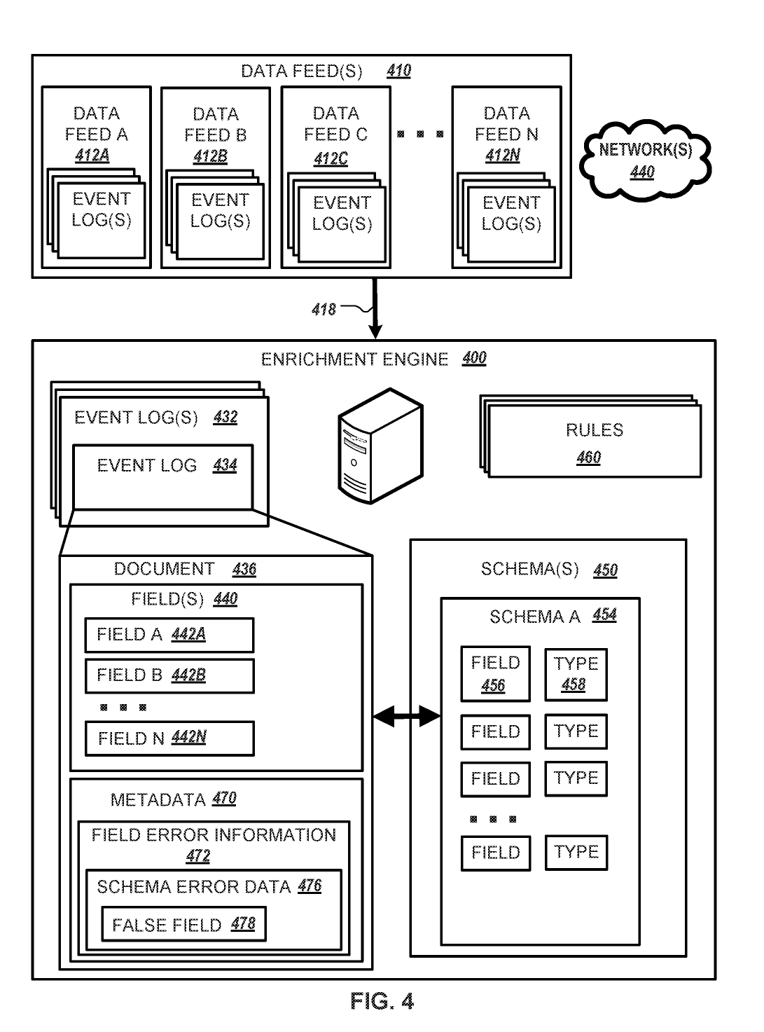

FIG. 4 is a diagram showing a technique for adding field error information to one or more event logs from one or more data feeds 410. The one or more data feeds 410, for example, can include various data feeds from disparate systems that can send event logs to the enrichment engine 400 over a period of time. In some implementations, a data feed (e.g., data flow) can include data provided from a data source consistently over a period of time. For example, one or more data sources can provide log information using event logs as a data feed to the enrichment engine 400. In some implementations, the data feeds 410 can represent data feeds from data sources that are monitored using rules-based detection which can include but is not limited to cybersecurity monitoring, SIEM monitoring, application monitoring, systems monitoring, and/or sensor monitoring. In some implementations, a data feed can include but is not limited to an event stream (e.g., KAFKA events, GOOGLE CLOUD Pub/Sub messages, etc.), log information, and/or other data feed.

In some implementations, event logs 432 of the one or more data feeds 410 can be collected by the enrichment engine 400 for processing for enrichment for inclusion into a data store. The enrichment engine 400 can process the received event logs 432 as they are received over time. For example, as event logs 432 are received from different data feeds the enrichment engine can enrich the event logs 432 as they are received in real-time. In another implementation, the enrichment engine, can process the event logs 432 in a predetermined order or in another suitable order. The enrichment engine 400 can be used in processing event logs according to any of the processes described and depicted herein including processes 200, 300, 500, and 800. The enrichment engine 400 can be implemented using one or more computing systems, as described and depicted herein. For example, the enrichment engine 400 can be implemented using the computing system 900 in FIG. 9. In some implementations, event logs and/or other described communications (e.g., data) can be sent and/or received using one or more communications networks 416. In some implementations, each data feed, for example, can provide event logs in a format such that the data included in an event log received from a data feed can have formats, types, and/or fields in an expected (e.g., predetermined) formatting and/or organization.

After being received by the enrichment engine 400, event logs such as event log 434 can be enriched such that the event log 434 can be reformatted and/or field error information can be added to the event log 434. In some implementations, an event log can be converted to an expected format that allows the event log to be stored into one or more data stores. As shown at 418, the event log 434 can be received from a first data feed 412A and can be formatted from a received format to a different format (e.g., data pattern). The event log 434 can be reformatted according to a standardized data format (e.g., a JSON format, etc.). The event log 434 can be formatted to include one or more documents (e.g., JSON documents) such as document 436. The event log 434 can include one or more data fields 440. As the event log 434 is received from the first data feed 412A, the reformatting can format the one or more data fields 440 according to a predetermined format used for the first data feed 412A. In some implementations, event logs received from other data feeds such as data feeds 412B-N can each be reformatted during enrichment according to formats determined for their respective providing data feeds.

The enrichment engine 400 can check expected formatting using one or more schemas 450. For example, a first schema 454 can be a schema that is designated for use to verify expected data formatting for event logs received from data feed 412A. Thus, the first schema 454 can be used to verify the expected formatting for event log 434. The event log 434, for example, can be parsed and compared to the first schema 454 for expected formatting. In some implementations, the schema 454 can be used to check for designated fields used by downstream processes. For example, the first schema 454 can be used to check for fields used in one or more rules 460 used by a rules-based monitoring system. In some implementations, a rules-based monitoring system can include but is not limited to a SIEM system, a cybersecurity system, a network security system, a sensor monitoring system, an application monitoring system, or other rules-based monitoring system. In some implementations, the one or more schemas 450, for example, can include a schema for each of the one or more data feeds 410. The event logs from each data feed can be compared using a respective schema for the appropriate data feed. In some implementations, a schema such as schema 454 can check for formatting including but not limited to field placement, field type, field presence, or other data formatting. For example, the first schema 454 can be used in part to check that the one or more fields 440 of event log 434 include an expected field 456 with field type 458 as designated by the first schema 450. In some implementations if a field is checked by the schema and determined to exist in the event log information indicating that the field exists can be added to the event log. If one or more fields of the event log 434 does not comply with the schema 454, the event log 434 can be tagged with field error information 472 including schema error data 476 which includes information of any failure to comply with the first schema 450. In some implementations, fields can fail to comply with a schema in various ways and the failure information can be included in the event log as field error information. In one example of a failure to comply with a schema, a field that is expected to be present in the event log is determined not to be present. In another example of a failure to comply with a schema, a field that is expected to be in a particular position in the event log is determined not to be in the expected position. In a further example of a failure to comply with a schema, a field that is expected to include data of a particular type is determined not to include data of the expected type. In an exemplary implementation, the field error information 472 can be added to be included in metadata 470 included in the event log 434. In some implementations, the field error information 472 can include schema error data 476. In the exemplary implementation shown in FIG. 4, the schema error data 474 includes information that one or more fields, based on the comparison with the first schema, are designated as false such as false field information 478.

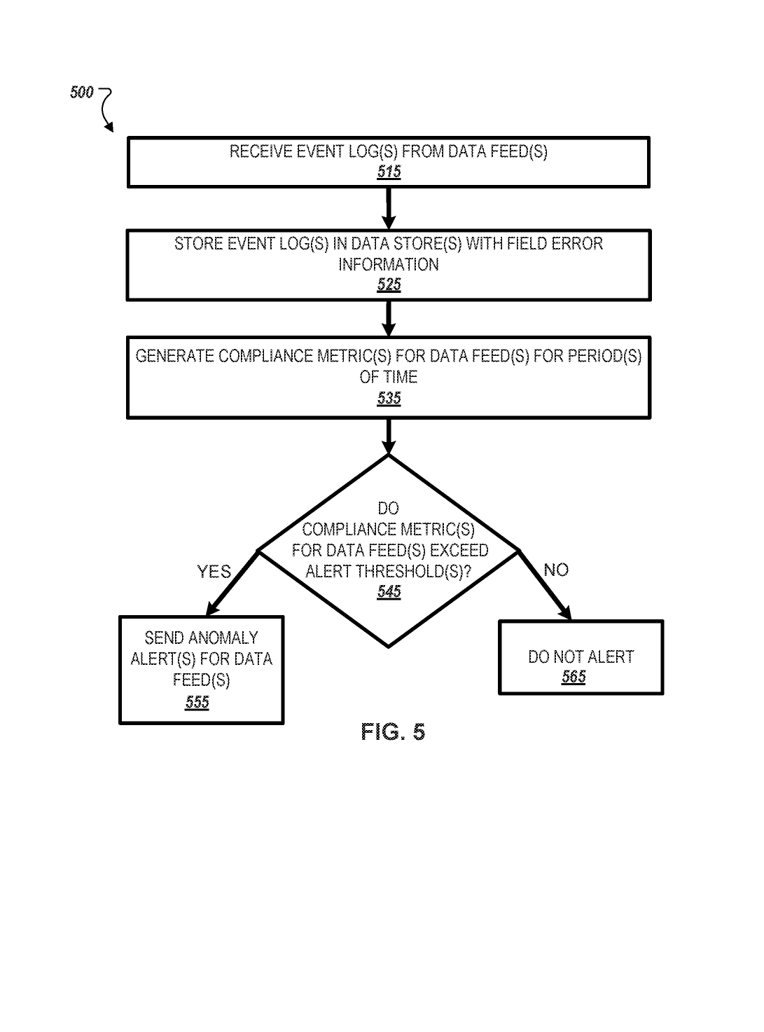

FIG. 5 is a flow diagram for an exemplary process 500 for sending one or more anomaly alerts for one or more data feeds. At 515, one or more event logs are received from one or more data feeds. At 525, the one or more event logs are stored with field error information in one or more data stores. At 535, one or more compliance metrics are generated for one or more periods of time for the one or more data feeds. At 545, a determination is made to determine if at least some of the compliance metrics for the one or more data feeds exceed at least some alert thresholds of one or more alert thresholds. If it is determined that at least some of the compliance metrics for the one or more data feeds exceed at least some alert thresholds of one or more alert thresholds, one or more alert thresholds are sent based on the determination. If it is determined that at least some of the compliance metrics for the one or more data feeds do not exceed at least some alert thresholds of one or more alert thresholds, anomaly alerts are not sent.

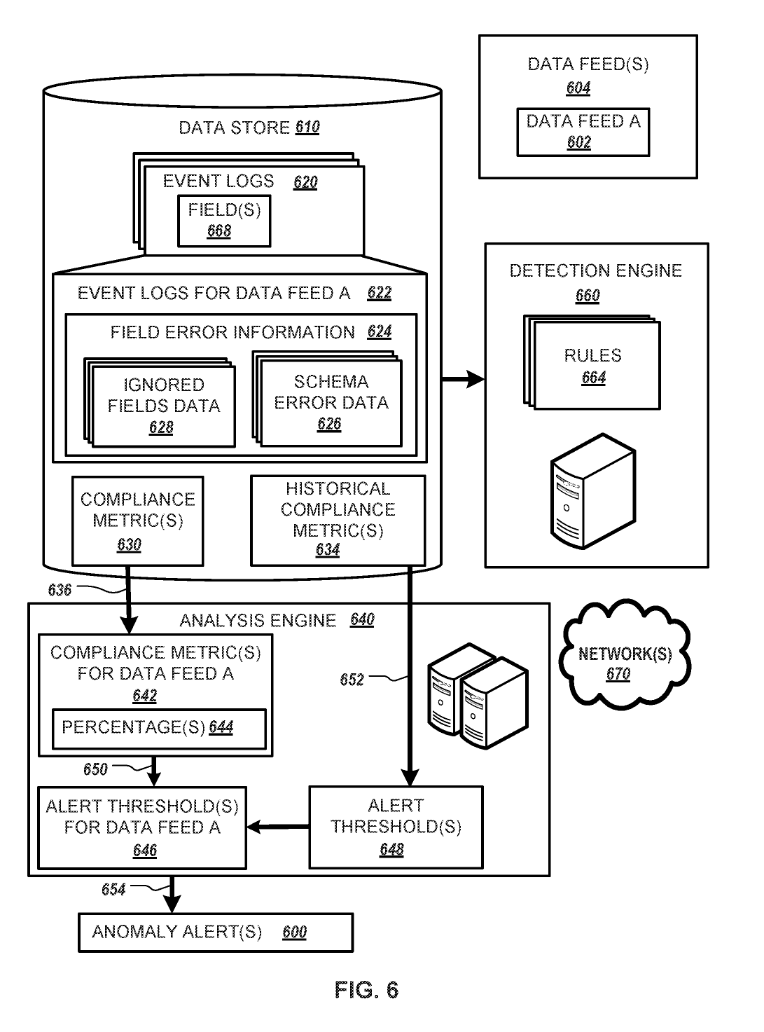

FIG. 6 is a diagram showing a technique for sending one or more anomaly alerts 600 for a first data feed 602. In FIG. 6, one or more event logs 620 for one or more data feeds 604 are stored in the data store 610. In some implementations, the data store 610 can include but is not limited to a distributed search engine (e.g., ELASTICSEARCH, etc.), a database, a search engine, and/or other searchable data store. The event logs 620 can include one or more event logs for the one or more data feeds 604 such as the event logs 622 for the first data feed 602. In some implementations, the event logs 620 can be ingested and stored in the data store 610 in real time or other times as each of the individual event logs are received at the data store 610 over time. As event logs 620 are stored they can be stored including and/or be stored associated with field error information 624. For example, as each of the event logs 622 for the first data feed 602 are ingested into the data store 610, one or more fields of each event log can be associated with field error information within the data store 610. The field error information 624 can include information about fields in the event logs that are malformed, false, ignored, or otherwise unsearchable within the data store 610. In some implementations, during the ingestion into the data store 610, the event logs 620 can be checked for compliance with an expected format which can include but is not limited to explicit mappings for datatypes and validation for designated fields. For example, the schema error data 626 can include information about fields that fail to comply with a schema for the first data feed 602. For example, the schema error data 626 can include data included in one or more event logs indicating the one or more fields do not comply with a designated schema based on expected data formatting for the first data feed 602. Also, for example, the ignored fields data 626 can include information about which fields of the event logs 620 include fields that are indicated as ignored. In some implementations, when a field of an event log fails to parse according to an expected format, the field can be indicated as ignored. In other implementations, a field can be indicated as ignored based on other data malformations and/or failures to comply with the expected format.

In some implementations, the field error information can include information based on one or more designated fields (e.g., important fields, critical fields, applicable fields, etc.) that are used by other processes that access the data included in the event logs 620 in the data store 610. For example, detection engine 660 can represent a system that uses one or more rules 664 to monitor the event logs of the one or more data feeds 604. The rules 664 can use one or more fields 668 included in the event logs 620 in a rules-based detection and/or monitoring system. In some implementations, the detection engine 660 can provide information about which fields are used by the detection engine 660 that can be monitored using one or more schemas and/or other field error information that can be stored for the event logs 620 in the data store 610. For example, the detection engine 660 can have an application programing interface to provide field information about what fields included in event logs for a designated data feed are used in rules to monitor the data feed and/or event logs. In some exemplary implementations, the schema used to monitor the data feed can be based on the field information provided by the detection engine for the fields of the data feed. In some implementations, the field information provided by the detection engine can be included in the criteria used to determine which of the one or more fields 668 of the stored event logs 620 are marked with field error information. In other implementations, the one or more fields 668 of the stored event logs 620 can be marked with field information using other criteria.

As shown in FIG. 6, one or more compliance metrics 630 can be determined (e.g., generated) based on the event logs 620 for the one or more data feeds 604. For example, the event logs 620 stored in the data store 610 can be queried (e.g., searched) for a count of event logs that include fields that include errors indicated by field error information to determine the compliance metrics 630. The data store 610 can include historical compliance metrics 634 for one or more data feeds 604. To monitor a first data feed 602, as shown at 636, an analysis engine 640 can receive one or more compliance metrics 642 for the first data feed 602 for a designated period of time. The one or more compliance metrics 642 for the first data feed 602 can include one or more counts of the event logs 622 such as percentage 644. For example, the percentage 644 can indicate the percentage of the event logs 622 received within the period of time that include and/or are associated with field error information 624. In some implementations, over various periods of time, percentages of event logs that include error information can change as formatting for the event logs changes over time. As shown at 650, the analysis engine 640 can compare the one or more compliance metrics 642 for the first data feed 602 with one or more alert thresholds 646 for the first data feed 602. The one or more alert thresholds 646 for the first data feed 602 can be included in the one or more alert thresholds 648 for the one of more data feeds 604. In some implementations, some of the one or more alert thresholds 648 can be set based on one or more historical compliance metrics 634 that can be provided to the analysis engine 640 as shown at 652.

As shown at 654, one or more anomaly alerts 600 can be sent based on the comparison of the one or more compliance metrics 642 for the first data feed 602 and the one or more alert thresholds for the first data feed 602. For example, based on the comparison, a determination can be made that one or more of the compliance metrics exceed one or more of the one or more alert thresholds. In some implementations, an anomaly alert can be sent for each of the one or more alert thresholds 646 that are exceeded for the first data feed 602. In other implementations, an anomaly alert can be sent for the first data feed 602 if one or more alert thresholds 646 are exceeded based on the comparison. In some implementations, the one or more anomaly alerts 600 can be transmitted via one or more channels that include but are not limited to email, text message, application message, terminal message, screen display message, system message, ticket in a ticketing system, and/or other channel. In some implementations, the one or more anomaly alerts 600 and/or other described communications can be sent and/or received using one or more communication networks 670. In some implementations, the one or more anomaly alerts 600 can include information (e.g., metadata, text, etc.) about which field and/or attribute of the data feed is associated with the anomaly alert. For example, if a field included in a data feed has changed and causes one or more alert thresholds to be exceeded for the data feed, a resulting anomaly alert can include information identifying the changed field. Identification of fields and/or attributes that have changed and caused and/or are associated with anomaly alerts can decreased time of investigation into anomaly alerts and changes to data feeds.

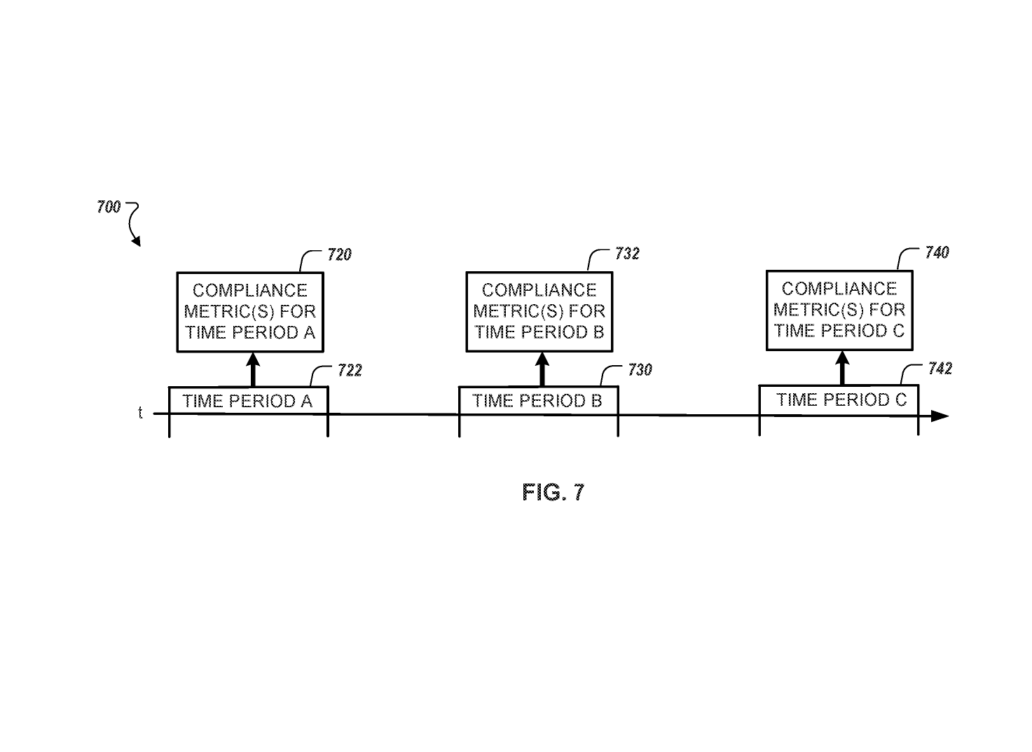

FIG. 7 is a diagram that shows an exemplary timeline 700 for receiving event logs from a data feed at a data store where one or more compliance metrics for various time periods are generated. In FIG. 7, one or more compliance metrics 720 are generated based on event logs received at the data store for the data feed during a first time period 722. For a second time period 730 that is later than the first time period 722, one or more compliance metrics 732 can be generated for the event logs received at the data store during the second time period 730. For a third time period that is later than the second time period 730, one or more compliance metrics 740 can be generated for the event logs received at the data store during the third time period 742. In some exemplary implementations, compliance metrics that are generated prior to a current time period can be used as historical compliance metrics for determining one or more alert thresholds. In some implementations, generating historical compliance metrics can include querying the data store for stored event logs with field errors indicated by error information for designated periods of time in real time or at another time.

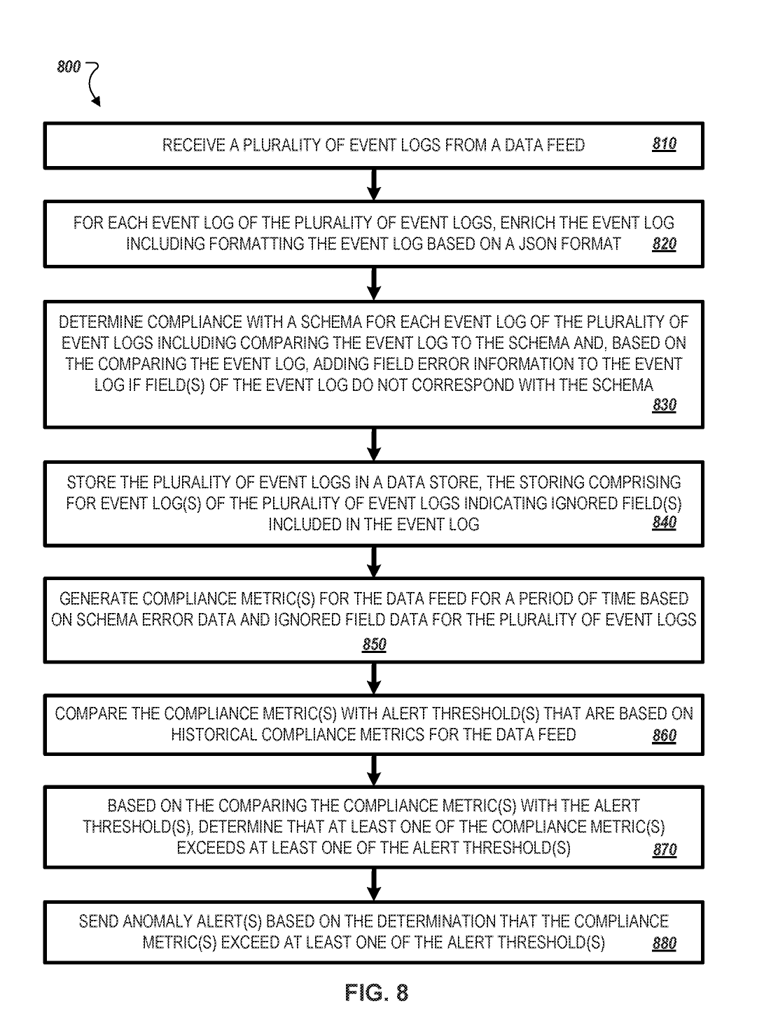

FIG. 8 is a diagram depicting an exemplary process 800 for sending one or more anomaly alerts for a data feed based on a determination that one or more compliance metrics exceed at least one of one or more alert thresholds. The process 800 can be performed using one or more computing systems, as described and depicted herein. For example, the process 800 can be performed using the computing system 900 in FIG. 9. At 810 in FIG. 8, a plurality of event logs is received from a data feed. For example, event logs can be received from a data feed over a period of time. At 820, for each event log of the plurality of event logs, the event log is enriched. The enriching of an event log can include formatting the event log based on a JSON format. At 830, compliance with a schema is determined for each event log of the plurality of event logs. The determining compliance with the schema can include comparing the event log to the schema. The determining compliance with the schema can also include adding field error information including schema error data to the event log if one or more fields of the even log do not correspond with the schema. At 840, the plurality of event logs is stored in the data store. The storing can include, for each event log of the plurality of event logs, indicating field error information including one or more ignored fields that are included in the event log. At 850, one or more compliance metrics are generated for the data feed for a period of time based on field error information for the plurality of event logs. At 860, the one or more compliance metrics are compared with one or more alert thresholds that are based on one or more historical compliance metrics for the data feed. At 870, based on the comparing the one or more compliance metrics with the one or more alert thresholds, a determination is made that at least one of the one or more compliance metrics exceeds at least one alert threshold of the one or more alert thresholds. At 880, an anomaly alert is sent based on the determination that the at least one of the one or more compliance metrics exceed at least one alert threshold of the one or more alert thresholds.

FIG. 9 is a schematic diagram that shows an example of a computing system 900 that can be used to implement the techniques described herein. The computing system 900 includes one or more computing devices (e.g., computing device 910), which can be in wired and/or wireless communication with various peripheral device(s) 980, data source(s) 990, and/or other computing devices (e.g., over network(s) 970). The computing device 910 can represent various forms of stationary computers 912 (e.g., workstations, kiosks, servers, mainframes, edge computing devices, quantum computers, etc.) and mobile computers 914 (e.g., laptops, tablets, mobile phones, personal digital assistants, wearable devices, etc.). In some implementations, the computing device 910 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 910, and an entire system can be made up of multiple devices communicating with each other. For example, the computing device 910 can be part of a computing system that includes a network of computing devices, such as a cloud-based computing system, a computing system in an internal network, or a computing system in another sort of shared network. Processors of the computing device (910) and other computing devices of a computing system can be optimized for different types of operations, secure computing tasks, etc. The components shown herein, and their functions, are meant to be examples, and are not meant to limit implementations of the technology described and/or claimed in this document.

The computing device 910 includes processor(s) 920, memory device(s) 930, storage device(s) 940, and interface(s) 950. Each of the processor(s) 920, the memory device(s) 930, the storage device(s) 940, and the interface(s) 950 are interconnected using a system bus 960. The processor(s) 920 are capable of processing instructions for execution within the computing device 910, and can include one or more single-threaded and/or multi-threaded processors. The processor(s) 920 are capable of processing instructions stored in the memory device(s) 930 and/or on the storage device(s) 940. The memory device(s) 930 can store data within the computing device 910, and can include one or more computer-readable media, volatile memory units, and/or non-volatile memory units. The storage device(s) 940 can provide mass storage for the computing device 910, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 950 can include various communications interfaces (e.g., USB, Near-Field Communication (NFC), Bluetooth, WiFi, Ethernet, wireless Ethernet, etc.) that can be coupled to the network(s) 970, peripheral device(s) 980, and/or data source(s) 990 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 950 can include a control interface that receives commands from an input device (e.g., operated by a user) and converts the commands for submission to the processors 920. The interface(s) 950 can include a display interface that includes circuitry for driving a display to present visual information to a user. The interface(s) 950 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 970 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 910 can communicate with the peripheral device(s) 980, the data source(s) 990, and/or other computing devices over the network(s) 970. In some implementations, the computing device 910 can directly communicate with the peripheral device(s) 980, the data source(s), and/or other computing devices.

The peripheral device(s) 980 can provide input/output operations for the computing device 910. Input devices (e.g., keyboards, pointing devices, touchscreens, microphones, cameras, scanners, sensors, etc.) can provide input to the computing device 910 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 910 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 990 can provide data for use by the computing device 910, and/or can maintain data that has been generated by the computing device 910 and/or other devices (e.g., data collected from sensor devices, data aggregated from various different data repositories, etc.). In some implementations, one or more data sources can be hosted by the computing device 910 (e.g., using the storage device(s) 940). In some implementations, one or more data sources can be hosted by a different computing device. Data can be provided by the data source(s) 990 in response to a request for data from the computing device 910 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 990a (e.g., databases, or other sorts of data management systems). The data store(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 990b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 990c. The machine learning system(s) 990c, for example, can be used to analyze data from various sources (e.g., data provided by the computing device 910, data from the data store(s) 990a, data from the blockchain(s) 990b, and/or data from other data sources), to identify patterns in the data, and to draw inferences from the data patterns. In general, training data 992 can be provided to one or more machine learning algorithms 994, and the machine learning algorithm(s) can generate a machine learning model 996. Execution of the machine learning algorithm(s) can be performed by the computing device 910, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks. With respect to the technology described herein, the training data can include data that represents data feed data. The machine learning model that results from the machine learning algorithm(s) can be used to monitor one or more data feeds for sending anomaly alerts. Use of the machine learning model can provide the benefit of efficiently sending one or more anomaly alerts based on detecting anomalous changes in one or more data feeds.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A computer system for alerting, the computer system comprising:
one or more processors; and
computer-readable memory storing instructions that, when executed by the processors, cause the processors to perform operations comprising:
receiving a plurality of event logs from a data feed;
determining compliance with a schema for each event log of the plurality of event logs;
storing the plurality of event logs in a data store, wherein the storing comprises, for one or more event logs of the plurality of event logs, indicating field error information;
generating one or more compliance metrics for the data feed for a period of time, wherein the one or more compliance metrics are generated based on field error information for the plurality of event logs;
comparing the one or more compliance metrics with one or more alert thresholds; and
sending one or more anomaly alerts based on the comparing with the one or more alert thresholds.

2. The computer system of claim 1, wherein the determining compliance with the schema comprises:
comparing an event log of the plurality of event logs to the schema; and
based on the comparing the event log, adding schema error data to the event log if one or more fields of the event log do not correspond with the schema.

3. The computer system of claim 1, wherein the operations further comprise:
for each event log of the plurality of event logs, enriching the event log, wherein the enriching comprises formatting the event log based on a JSON format.

4. The computer system of claim 1, wherein the operations further comprise:
based on the comparing the one or more compliance metrics with the one or more alert thresholds, determining that at least one of the compliance metrics exceeds at least one of the alert thresholds.

5. The computer system of claim 1, wherein the one or more alert thresholds are based on one or more historical compliance metrics for the data feed.

6. The computer system of claim 4, wherein the sending of the one or more anomaly alerts is further based on the determination that the at least one of the compliance metrics exceeds the at least one alert threshold; and
wherein the one or more alert thresholds are based on one or more historical compliance metrics for one or more designated fields included in the data feed.

7. The computer system of claim 5, wherein the one or more historical compliance metrics for the data feed are based on a cyclical time period for the data feed.

8. The computer system of claim 1, wherein the one or more compliance metrics include a percentage of event logs that include one or more unsearchable fields.

9. The computer system of claim 1, wherein the one or more compliance metrics are generated further based on unsearchable fields of the plurality of event logs.

10. A method for anomaly alerting, the method comprising:
receiving a plurality of event logs from a data feed;
determining compliance with a schema for each event log of the plurality of event logs;
storing the plurality of event logs in a data store, wherein the storing comprises, for one or more event log of the plurality of event logs, indicating field error information;
generating one or more compliance metrics for the data feed for a period of time, wherein the one or more compliance metrics are generated based on field error information for the plurality of event logs;
comparing the one or more compliance metrics with one or more alert thresholds; and
sending one or more anomaly alerts based on the comparing with the one or more alert thresholds.

11. The method of claim 10, wherein the determining compliance with the schema comprises:
comparing an event log of the plurality of event logs to the schema; and
based on the comparing the event log, adding schema error data to the event log if one or more fields of the event log do not correspond with the schema.

12. The method of claim 10, wherein the method further comprises:
for each event log of the plurality of event logs, enriching the event log, wherein the enriching comprises formatting the event log based on a JSON format.

13. The method of claim 10, wherein the method further comprises:
based on the comparing the one or more compliance metrics with the alert threshold, determining that at least one of the one or more compliance metrics exceed the alert threshold.

14. The method of claim 10, wherein the alert threshold is based on one or more historical compliance metrics for the data feed.

15. The method of claim 13, wherein the sending of the one or more of the anomaly alerts is further based on the determination that the at least one of the one or more compliance metrics exceed the alert threshold; and wherein the alert threshold is based on one or more historical compliance metrics for a designated field of the data feed.

16. The method of claim 14, wherein the one or more historical compliance metrics for the data feed are based on a cyclical time period for the data feed.

17. The method of claim 10, wherein the one or more compliance metrics include a percentage of the event logs that include one or more unsearchable fields.

18. The method of claim 10, wherein the schema is based on one or more fields used by one or more rules for rules-based detection.

19. The method of claim 10, wherein the compliance metrics are generated based further on unsearchable fields of the plurality of event logs.

20. A method for anomaly alerting, the method comprising:
receiving a plurality of event logs from a data feed;
for each event log of the plurality of event logs, enriching the event log, wherein the enriching comprises formatting the event log based on a JSON format;
determining compliance with a schema for each event log of the plurality of event logs, wherein the determining compliance with the schema comprises comparing the event log to the schema and, based on the comparing the event log, adding field error information to the event log if one or more fields of the event log do not correspond with the schema;
storing the plurality of event logs in a data store, wherein the storing comprises, for one or more event logs of the plurality of event logs, indicating ignored fields included in the event log;
generating one or more compliance metrics for the data feed for a period of time, wherein the one or more compliance metrics are generated based on schema error data and ignored field data for the plurality of event logs;
comparing the one or more compliance metrics with one or more alert thresholds, wherein the one or more alert thresholds are based on one or more historical compliance metrics for the data feed;
based on the comparing the one or more compliance metrics with the one or more alert thresholds, determining that at least one of the one or more compliance metrics exceeds at least one alert threshold of the one or more alert thresholds; and
sending one or mor anomaly alerts based on the determination that the at least one of the one or more compliance metrics exceeds the at least one alert threshold of the one or more alert thresholds.
